(19) United States
(12) Patent Application Publication
(10) Pub. No.: US 2014/0098650 A1
(43) Pub. Date: Apr. 10, 2014

(54) REVOLVING BEZEL SYSTEM FOR A TIMEPIECE AND TIMEPIECE COMPRISING SUCH A SYSTEM

(71) Applicant: BALL WATCH COMPANY SA, La-Chaux-de-Fonds (CH)

(72) Inventor: Philippe Antille, La Neuveville (CH)

(73) Assignee: Ball Watch Company SA, La Chaux-de-Fonds (CH)

(21) Appl. No.: 13/644,898

(22) Filed: Oct. 4, 2012

(51) Int. Cl. G04B 37/12

(52) U.S. Cl. 368/295

(57) ABSTRACT

The present disclosure relates to a revolving bezel system for a timepiece. The timepiece may include a middle, a revolving bezel having teeth and at least one marker on a visible face, and an indexing member configured to cooperate with the teeth to index angular positions of the revolving bezel. In accordance with an embodiment of the present disclosure, the revolving bezel system includes a mounting configured to bear the indexing member and on which the revolving bezel is configured to be mounted to rotate. The system further includes first fixing elements and second fixing elements configured to provide a fixing for the mounting on the middle, the fixing being rigid while allowing for an angular adjustment of the position of the mounting in relation to the middle, within a predefined angular range. The system also includes positioning elements configured to securely attach the indexing member in rotation to the mounting.

### TECHNICAL FIELD

The present disclosure relates to the technical field of horology, and more specifically to a revolving bezel system for a timepiece, such as a diver's watch. The present disclosure also concerns a timepiece comprising such a revolving bezel system.

### BACKGROUND

Many timepieces are provided with a revolving bezel system which enables the user to quickly determine a duration. Such is, for example, the case when they are used when practicing an activity such as underwater diving, by a diver who has to remain aware of the current dive duration, for safety reasons.

In such timepieces, a revolving bezel is arranged on the watch case, generally fixed to the middle of the case with a degree of freedom in rotation about the axial direction of the watch case.

Conventionally, the revolving bezel may comprise a circular graduation on its visible upper face, generally of 60 equal divisions each of which corresponds to a time unit, for example a second or a minute. The different angular positions of the revolving bezel can be measured in relation to a time readout produced in connection with a fixed dial relative to the middle.

Conventionally, the revolving bezel may also comprise a circular toothing, having a pitch corresponding to the above-mentioned graduation. An appropriate member, securely attached to the middle and cooperating with the teeth of the revolving bezel, makes it possible to index discrete angular positions of the revolving bezel in relation to the middle. To this end, it is known practice to use a ring securely attached in rotation to the middle, and provided with flexible tongues.

When the revolving bezel is not in use, it can be returned to a neutral position in relation to the middle. In this neutral position, the graduation of the bezel corresponding to a rotation of “zero degrees” in relation to the middle is normally aligned with the “6 o'clock 12 o'clock” direction shown on the dial.

However, it may be that the “zero degrees of rotation” graduation of the revolving bezel cannot be made to coincide satisfactorily with the “6 o'clock-12 o'clock” direction of the dial. This may be because the manufacturing tolerances do not always allow for an appropriate fit of the different components of the timepiece at the time of their assembly.

An angular deviation may then be observed between the two directions, for example, almost up to six degrees for a revolving bezel with 60 graduations, that is to say 60 indexed angular positions. Despite its small value, such an angular deviation may, however, be sufficiently perceptible to detract from the aesthetic appearance of the timepiece.

### SUMMARY

The present disclosure may provide a solution to the above-mentioned problems.

To this end, the present disclosure relates more particularly to an improved revolving bezel system for a timepiece, the timepiece being of the type including a middle, a revolving bezel having at least one marker on a visible face and also having teeth, and an indexing member cooperating with the teeth to index angular positions of the revolving bezel.

According to one feature of the disclosure, the revolving bezel system may include a mounting configured to bear the indexing member and on which the revolving bezel is configured to be mounted to rotate. The revolving bezel may also include first fixing elements and second fixing elements configured to provide a fixing for the mounting on the middle, the fixing being rigid while allowing for an angular adjustment of the position of the mounting in relation to the middle, within a predefined angular range, and positioning elements configured to securely attach the indexing member in rotation to the mounting. That is, the positioning elements may be configured to attach the indexing member to the mounting such that the indexing member and the mounting may rotate with respect to one another.

Thus, unlike the conventional revolving bezel systems, the indexing of the revolving bezel is produced, not directly in relation to the middle, but in relation to an intermediate mounting whose position can be adjusted in relation to the middle.

For a given indexing position of the revolving bezel, the latter is immobile in relation to the mounting. Consequently, for a given indexing position, an adjustment of the position of the mounting in relation to the middle amounts to an adjustment of the position of the revolving bezel in relation to the middle.

It follows therefrom that the two functions of indexing of the revolving bezel in relation to the mounting and of adjustment of the revolving bezel in relation to the middle are dissociated.

The mounting may take the form of a ring, configured to be screwed onto the middle, or onto an added-on piece that is fixed in relation to the middle and securely attached thereto.

The present disclosure also relates to a timepiece case, comprising a revolving bezel system as mentioned previously, and also comprising a middle and an indexing member.

According to one feature of the disclosure, the timepiece case may include third fixing elements which cooperate with the first fixing elements to provide a rigid fixing of the mounting on the middle, and immobilizing elements securely attached to the indexing member, which cooperate with the positioning elements to immobilize in rotation the indexing member in relation to the mounting. That is, the immobilizing elements may be configured to prevent the rotation of the indexing member with respect to the mounting.

According to an embodiment of the present disclosure, the first fixing elements include a threading of the mounting and the third fixing elements include a threading of the middle, and the two threadings cooperate to produce a rigid fixing of the mounting on the middle.

A screwed fixing may offer an advantage compared to other fixing methods. In practice, beyond a certain amount of screwing for which a rigid fixing of the mounting on the middle is obtained, there is still an angular screwing range within which it is possible to slightly vary the relative positions of the mounting and of the middle while retaining a rigid fixing between the mounting and the middle.

According to an embodiment of the disclosure, the second fixing elements include a seal, interposed between the mounting and the middle and capable of being deformed in order to make it possible to perform the angular adjustment.

The mechanical specifications and properties of this seal can be chosen so that the value of the angular range of screwing is a few degrees. Thus, the angular position of the mounting on the middle can be adjusted without affecting the rigid fixing of the mounting on the middle. In this way, the mounting and the middle remain rigidly linked to one another within a range of angular adjustment of the mounting in relation to the middle.

According to an embodiment of the disclosure, the positioning elements include at least one notch formed in the mounting and the immobilizing elements include at least one tab of the indexing member, this tab cooperating with a notch which may prevent any rotation of the indexing member in relation to the mounting.

According to another feature of the disclosed embodiments, the revolving bezel system also includes mounting elements for a rotary mounting of the revolving bezel on the mounting.

The present disclosure also relates to a timepiece including a revolving bezel system and/or a case as mentioned above, such as a diver's watch.

### BRIEF DESCRIPTION OF THE DRAWINGS

Other features and advantages of the disclosed embodiments will become more clearly apparent on reading the following detailed description with reference to the appended drawings given as nonlimiting examples and in which:

FIG. 1 is a partial transversal cross section in the direction 9h-3h of a timepiece having a revolving bezel system according to the description;

FIG. 2 is a plan view of the timepiece of FIG. 1;

FIG. 3 is a partial transversal cross section of a mounting according to the description;

FIG. 4 represents a perspective and plan partial view of the mounting of FIG. 3;

FIG. 5 is a partial view, in transversal cross section, illustrating the fixing of the mounting on the middle and the arrangement of the indexing member in relation to the mounting;

FIG. 6 is a partial transversal cross-sectional view of a revolving bezel according to the description;

FIG. 7 is an enlarged view of a detail of FIG. 1, more particularly illustrating the rotary mounting of the revolving bezel on the mounting;

FIG. 8 is a plan view of an indexing member according to the description; and

FIG. 9 represents a detail of the indexing member, in cross section along the line IX-IX of FIG. 8 and on a larger scale.

### DETAILED DESCRIPTION

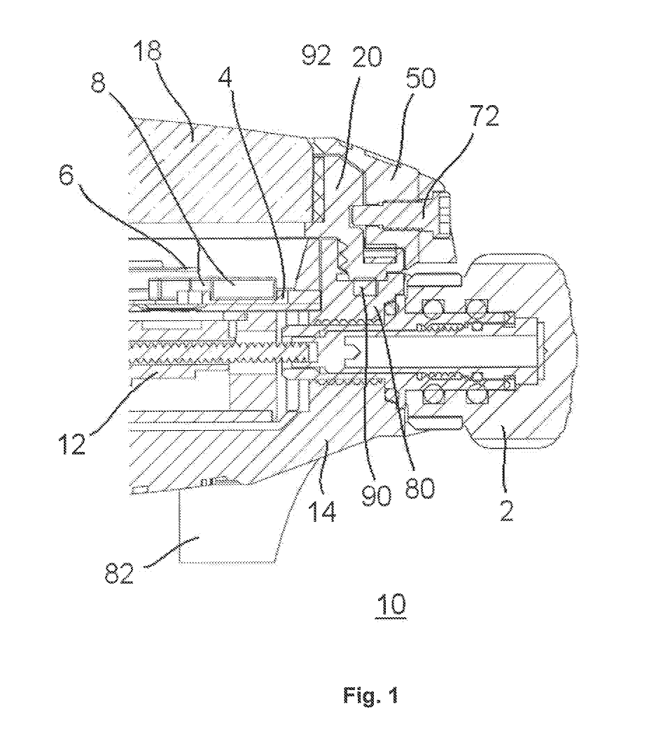

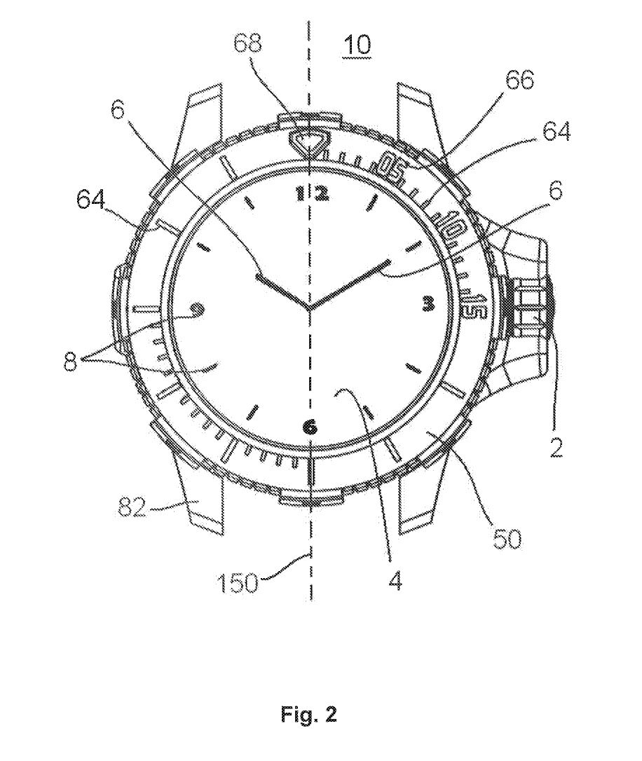

FIGS. 1 and 2 are overall views, respectively in partial transversal cross section and in a plan view, of a timepiece 10 having a movement 12 contained in a case including a bottom 14 and a middle 80.

FIGS. 1 and 2 also show horns 82 of the middle 80, a time-setting crown 2, a dial 4, needles 6 and index markings 8 for displaying the time, an example of the latter being numerals or lines oriented radially. In the example illustrated, the index markings 8 are represented by luminescent tubes.

The timepiece also includes a watch-glass 18 and a revolving bezel 50 which are both borne by an intermediate mounting 20 taking the form of a ring screwed onto the middle 80.

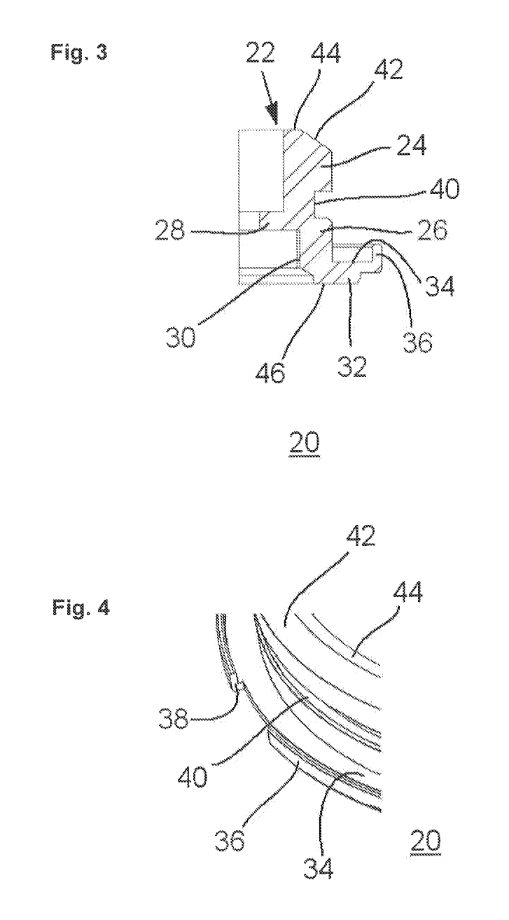

The mounting 20 is illustrated in FIGS. 3 and 4, respectively in partial transversal cross section and in a partial perspective view from above.

The mounting 20 includes a body 22 of overall cylindrical form having a top part 24 and a bottom part 26 between which a shoulder 28 extends radially inward. In the bottom part 26, a threading 30 is produced on the internal wall of the body 22.

A collar 32 extends radially outward from the bottom part 26. An annular groove 34 is hollowed out on the top face of the collar 32, being delimited on one side by the external wall of the body 22 and on the other side by a flange 36. As illustrated in FIG. 4, notches 38, produced on the periphery of the collar 32, introduce interruptions on the flange 36. According to a nonlimiting embodiment, there can be four notches 38, evenly distributed along the periphery of the collar 32.

Moreover, a lateral groove 40 is hollowed out in the external wall of the body 22. In the example illustrated, the groove 40 is roughly at the same level as the shoulder 28; however, other implementations may be possible, as the respective roles of the groove 40 and of the shoulder 28 are distinct.

The body 22 also has an oblique face 42 toward the top of its external wall. The body 22 also has two bearing faces 44, 46, substantially planar and perpendicular to its axial direction, respectively, a top bearing face 44, and a bottom bearing face 46.

The mounting 20 may play a central role and cooperate with a number of other components of the timepiece 10, as will be described below.

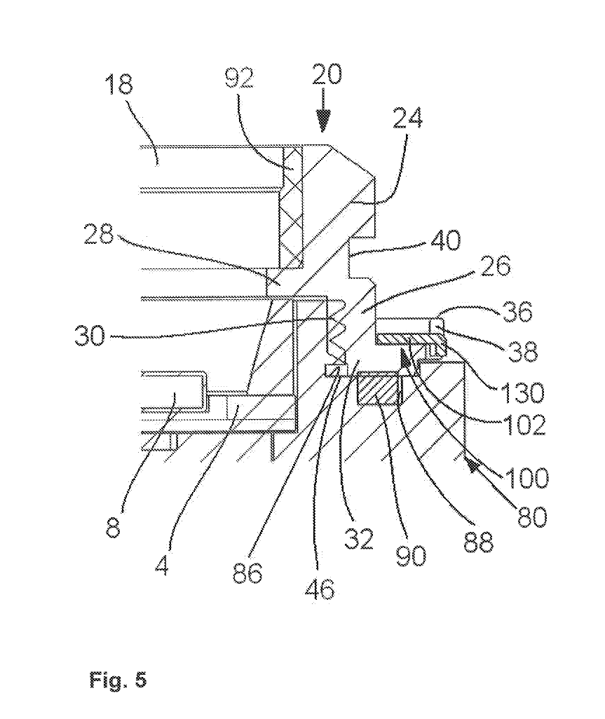

According to a first aspect illustrated in FIG. 5, the mounting 20 is fixed onto the middle 80 by screwing. To this end, a threading 30 is produced on at least a part of a lateral wall of the mounting 20, and a threading 84 is produced on at least part of a lateral wall of the middle 80. In some instances, the threading 30 is produced on the internal wall of the bottom part 26 of the mounting 20 and the threading 84 is produced on an external and upper wall of the middle 80.

The two threadings 30, 84 are arranged and dimensioned in such a way as to produce a rigid fixing of the mounting 20 on the middle 80. More particularly, in some instances the rigid fixing between the mounting 20 and the middle 80 does not correspond to a single relative angular position of the mounting 20 in relation to the middle 80, but to a range of relative angular positions.

This angular range may be between 0 and 10 degrees. In some examples, is the angular range may be between 0 and 6 degrees, or between 0 and 3 degrees.

The fixing of the mounting 20 on the middle 80 is, furthermore, stabilized by the presence of the bottom bearing face 46 of the mounting 20, which may co-operate with a top bearing face 86 of the middle 80, depending on the level of tightness of the mounting 20 on the middle 80.

In practice, an annular seal 90 may be arranged between the mounting 20 and the middle 80, in an annular groove 88 hollowed out in the middle 80 from its top bearing face 86. Thus, the bottom bearing face 46 of the mounting 20 holds the seal 90 in the groove 88 by compressing it when the mounting 20 is screwed onto the middle 80.

The seal 90 is inherently deformable by compression and torsion. Its crushing favors not only the seal-tightness of the timepiece 10, but also the stabilization of the mounting 20 on the middle 80. Furthermore, the ability to withstand a slight torsion allows for the angular adjustment between the mounting 20 and the middle 80, by applying a few degrees of screwing between these two parts.

According to a second aspect also illustrated in FIG. 5, the mounting 20 receives the watch-glass 18 which rests on the internal shoulder 28. The watch-glass 18 may be driven into the opening defined by the top part 24 of the body 22, with a seal packing 92 interposed. It is thus possible to access the movement 12, for example, to ensure its maintenance, by unscrewing the mounting 20 from the middle 80, without risking damaging the watch-glass 18. If the watch-glass 18 was driven directly onto the middle 80, in the absence of an intermediate mounting, it may be difficult to access the movement without damaging the watch-glass 18, because the production of the middle 80 and the bottom in a single piece means that the movement 12 may not be accessible via the bottom either.

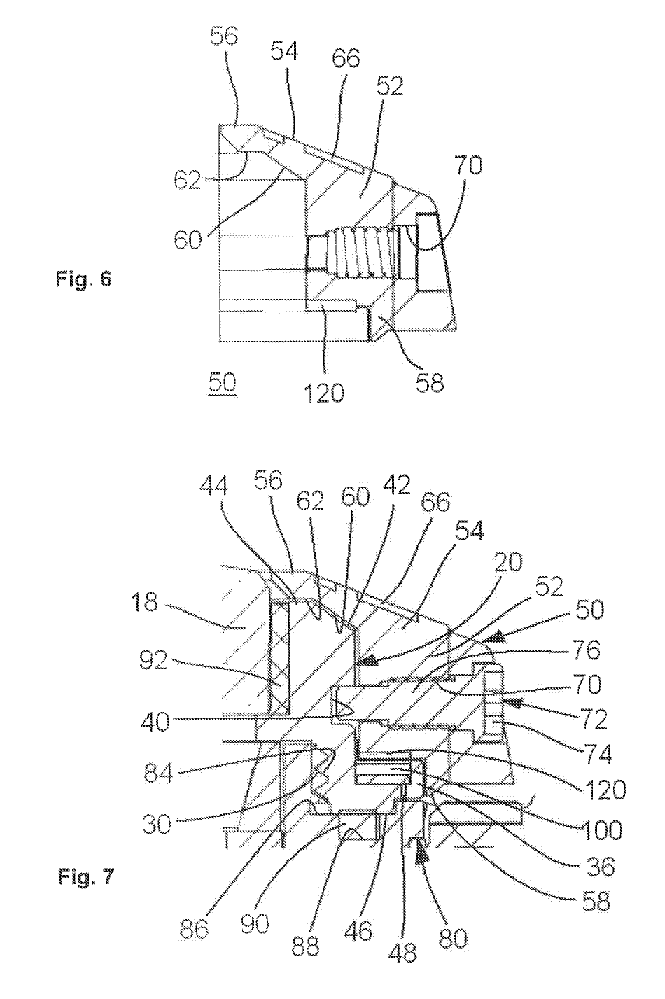

According to a third aspect, the mounting 20 receives the revolving bezel 50, which will be described with reference to FIGS. 6 and 7, in which it is represented in partial transversal cross section, alone and mounted on the mounting 20, respectively.

The revolving bezel 50 has a body 52 of overall annular form. The body 52 is extended upward by a tapered part 54 which narrows to an annular summit 56, and downward by a recess 58, which allows the body 52 to be fitted on the collar 32 of the mounting 20, covering the flange 36.

The revolving bezel 50 is stably positioned on the mounting 20. To this end, the tapered part 54 has an internal oblique face 60 and the summit 56 has an internal bearing face 62, which follow the form of the oblique face 42 and the top bearing face 44 of the mounting 20, respectively. The summit 56 covers not only the top part 22 of the mounting 20 but also the seal packing 92 and masks the latter, which may enhance the aesthetic appearance of the timepiece 10.

The revolving bezel system 50 includes mounting elements 70, 72, 40 for a rotary mounting of the revolving bezel 50 on the mounting 20, which include holes 70, screws 72 and the groove 40. More specifically, screws 72 are screwed into holes 70, which pass radially through the body 52 of the revolving bezel 50 and which are positioned in such a way that, in service, they are located facing the lateral groove 40 of the mounting 20.

The screws 72 each have a head 74, a body 76, which is at least partially threaded, and a non-threaded free end 78. Each of the head 74, body 76, and free end 78 can cooperate with three successive sections of the holes 70, the diameters of which are in descending order from outside to inside, the intermediate section of holes 70 being at least partially threaded.

In service, the free ends 78 of the screws 72 may extend beyond the interior of the body 52 and be received in the lateral groove 40, which may help to hold the revolving bezel 50 on the mounting 20. Because the free ends 78 of the screws 72 can slide in the groove 40, the revolving bezel 50 may be free to revolve relative to the mounting 20. By virtue of their respective complementary forms, the oblique faces 42, 60 and the bearing faces 44, 62 act as rotation-guiding faces.

In the example illustrated in the figures, there are eight holes 70 and screws 72, but this implementation may not be limiting, as there may be more or less holes 70 and corresponding screws 72.

The revolving bezel 50 also includes annular teeth 120. In the example illustrated, the teeth 120 are arranged on a face of the body 52 which is substantially perpendicular to its axial direction. When the revolving bezel 50 is in place on the mounting 20, the teeth 120 face the annular groove 34 of the collar 32, whereas the recess 58 covers the flange 36 of the collar 32.

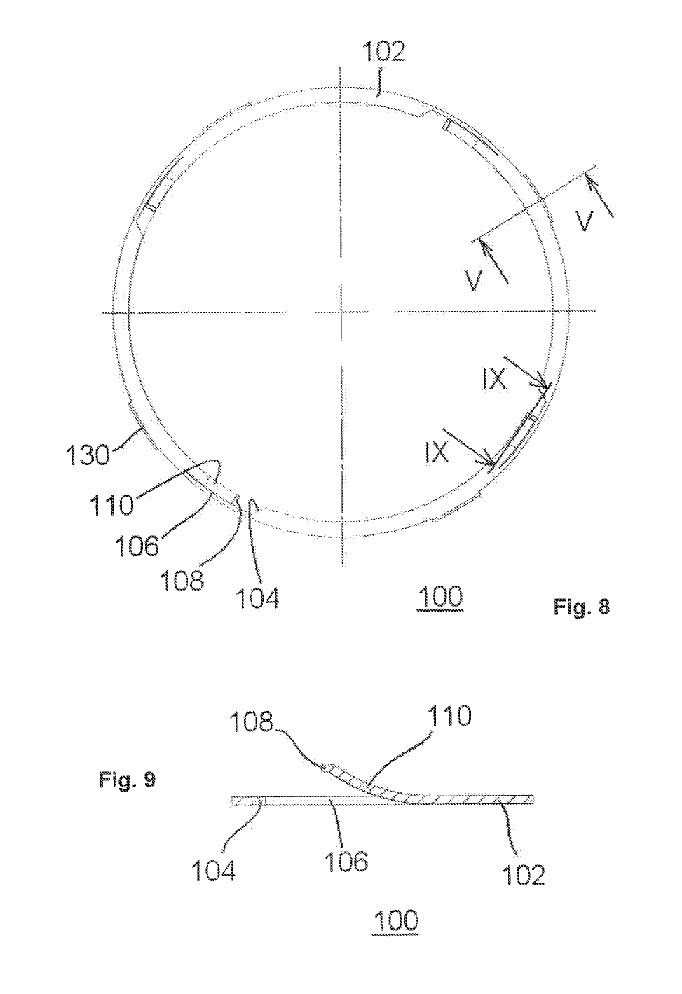

According to a fourth aspect, the mounting 20 receives an indexing member 100, which will be described with reference to FIGS. 8 and 9, in which it is represented in plan view and by a partial longitudinal cross section, respectively.

The indexing member 100 may be in the form of a substantially flat metal ring 102. The indexing member 100 may include tabs 130 extending in a direction substantially perpendicular to the median plane of the ring 102. In the example illustrated, there are four tabs 130, which may be evenly distributed on the ring 102. Even distribution of the tabs 130, however, is not limiting, as the tabs 130 may be unevenly distributed in some instances.

FIG. 5 shows the indexing member 100 in transversal cross section along the line V-V of FIG. 8. FIG. 5 shows the indexing member 100 passing through a tab 130, which is arranged in a notch 38 of the collar 32.

In practice, the groove 34 of the collar 32 constitutes a receptacle for the indexing member 100 whose tabs 130 are exactly positioned in the notches 38. The respective numbers, placements and dimensions of the tabs 130 and of the notches 38 are chosen such that the tabs 130 are retained in the notches 38. The tabs 130 and notches 38 may also be referred to herein, either separately or together, as positioning elements or the like. Thus, the positioning elements may be configured to securely attached the indexing member 100 in rotation to the mounting 20, that is, the indexing member 100 and the mounting 20 may rotate with respect to one another.

The indexing member 100 also includes cutouts 104 (FIGS. 8 and 9), which open toward the interior of the ring 102 and which are each extended by a slot 106 having a circumferential direction, so as to define tongues 110. Each of the tongues 110 may be pushed back by deflection from one and the same side of the median plane of the ring 102, and free ends 108 of the tongues 110 may be slightly folded in the form of a hook in a plane parallel to the median plane of the ring 102. The constituent material of the ring 102 and the dimensions of the tongues 110 may be chosen so as to confer on said tongues 110 a certain elasticity in deflection. In the example illustrated, there are four tongues 110, evenly distributed along the internal periphery of the ring 102, while being offset in relation to the tabs 130. This distribution, however, is not limited, as more or less tongues 110 may be distributed along the internal periphery of the ring, evenly or unevenly.

The tongues 110 can cooperate with the teeth 120 of the revolving bezel 50 when the revolving bezel 50 and the indexing member 100 are both in place on the mounting 20, as illustrated in FIG. 7.

The user manually actuates the revolving bezel 50 to make it revolve about the mounting 20 by sliding the free ends 78 of the screws 72 in the groove 40 of the mounting 20. The indexing member 100 is arranged in the groove 34 of the mounting 20 and may be unable to revolve in relation thereto, due to the tabs 130 being placed in the positioning notches 38. Consequently, the revolving bezel 50 also revolves in relation to the indexing member 100. During this rotation, the teeth 120 of the revolving bezel 50 are successively hooked by the ends 108 of the flexible tongues 110 of the indexing member 100. The teeth 120 may define notches for the tongues 110, between which they can be displaced by elastic deformation. Thus, a user can revolve the revolving bezel 50 step by step, which makes it possible to index the bezel 50 in as many discrete indexing positions as there are teeth 120. In particular, the revolving bezel 50 may revolve in an indexed manner not only in relation to the mounting 20, but also in relation to the middle 80 on which the mounting 20 is rigidly fixed, and also in relation to the dial 4 which is fixed in relation to the middle 80.

The revolving bezel 50 may also include markers 64, 66, 68 on the external and visible face of its tapered part 54, as illustrated in FIGS. 2 and 6. These markers 64, 66, 68 make it possible to display time information in connection with the time display means of the timepiece 10. In some instances, the markers 64, 66, 68 can take the form of radially-oriented lines 64, numerals 66, or a form to represent a reference pointer 68. In the example illustrated, the pointer 68 is substantially triangular. The pointer 68 can be used to mark the start of a measured time interval, or to indicate the neutral “zero degrees of rotation” position of the revolving bezel 50 in relation to the dial 4 on which time display index markers 8 are located, when it is positioned at 12 o'clock.

In FIG. 2, the revolving bezel 50 is represented in its neutral position, that is, the reference pointer 68 is aligned with the 6 o'clock-12 o'clock direction of the display of the dial 4.

This alignment, represented schematically by the axis 150, is made possible independently of the manufacturing tolerances of the elements of the timepiece 10, in particular, of the revolving bezel 50 and of the middle 80. The following factors may contribute to the alignment being possible independently of the manufacturing tolerances of the elements of the timepiece 10: the revolving bezel 50 may not be mounted directly on the middle 80 but on an intermediate mounting 20; and/or the angular position of the mounting 20 on the middle 80 may be adjustable by virtue of the angular range within which the link by screwing allows for a rigid fixing between the mounting 20 and the middle 80.

The timepiece 10 may also offer advantages in terms of seal-tightness, making it possible to use the timepiece 10 as a diver's watch.

In practice, in the examples illustrated in the figures, the bottom 14 and the middle 80 can be made of a single piece. While this implementation is not required, it may offer the advantage of conferring on the case a seal-tightness and a mechanical strength that are enhanced compared to the cases in which the bottom and the middle are produced as two distinct pieces.

Furthermore, the seal 90, interposed between the mounting 20 and the middle 80, is positioned on the side of the external environment relative to the threadings 30, 84. This may help to rigidly fix these two pieces together to promote the seal-tightness of the timepiece 10.

FIG. 7 illustrates an additional feature of the timepiece 10 according to the present disclosure.

The arrangement of the pieces relative to one another defines a flow path for the water which may penetrate into the space that exists between the summit 56 and the watch-glass 18, and then flow between the revolving bezel 50 and the mounting 20. This water can then be evacuated outward through the notches 38 of the mounting 20. The evacuation can be facilitated by the operational presence of at least one water evacuation element in the mounting 20. In some instances, the water evacuation element may be in the form of at least one hole 48 which passes through the collar 32 or of a notch 38, which would not be associated with a tab 130 of the indexing member 100. Thus, the water which penetrates between the revolving bezel 50 and the mounting 20 would not stagnate under the revolving bezel 50 because its flow can be facilitated.

The present disclosure is not limited to the embodiments just described, and extends to all the variants within the reach of the person skilled in the art.

As an example, the threading 84, which may cooperate with the threading 30 by meshing with the threading 30, could be produced not on the middle 80 but on an added-on piece, which would be arranged between the mounting 20 and the middle 80 and rigidly fixed thereto. Thus, the angular adjustment between the mounting 20 and the middle 80 would result from an angular adjustment between the mounting 20 and this added-on piece.

Moreover, the annular teeth 120 of the revolving bezel 50 could be arranged not on a perpendicular face, but on a face parallel to the axial direction of the body 52, for example, on its external wall. In such an arrangement, the flexible tongues of the indexing member would be arranged on a lateral face of the latter, for example on its internal wall, so as to be located facing the teeth.

It will also be noted that the present disclosure can be applied to other types of revolving bezels other that described above, such as, for example, a revolving bezel for a pilot's watch with slide rule, without departing from the scope of the present.

What is claimed is:

1. A revolving bezel system for a timepiece comprising a middle, a revolving bezel having teeth and at least one marker on a visible face, and an indexing member configured to cooperate with said teeth to index angular positions of said revolving bezel, wherein the system comprises;
a mounting configured to bear said indexing member and on which said revolving bezel is configured to be mounted to rotate;
first fixing elements and second fixing elements configured to provide a fixing for the mounting on said middle, said fixing being rigid while allowing for an angular adjustment of the position of said mounting in relation to said middle, within a predefined angular range; and
positioning elements configured to securely attach said indexing member in rotation to said mounting.

2. The system of claim 1, wherein said mounting is a ring configured to be screwed onto either said middle or an added-on piece securely attached to said middle.

3. The system of claim 2, wherein said first fixing elements comprise a threading of said mounting.

4. The system of claim 3, wherein said second fixing elements comprise a seal interposed between said mounting and said middle and capable of being compressed in order to allow for said angular adjustment between said mounting and said middle.

5. The system of claim 1, wherein said mounting comprises a receptacle for said indexing member arranged on a face and configured to be located facing said teeth.

6. The system of claim 1, wherein said positioning elements comprise at least one notch formed in said mounting.

7. The system of claim 1, wherein said mounting comprises a shoulder extending radially inward and configured to accommodate a watch-glass driven into said mounting.

8. A timepiece case comprising:
a middle;
a revolving bezel having teeth and at least one marker on a visible face;
an indexing member configured to cooperate with said teeth to index angular positions of said revolving bezel;
a revolving bezel system comprising:
a mounting bearing said indexing member and on which said revolving bezel is mounted and configured to rotate;
first fixing elements and second fixing elements configured to securely attach said mounting and said middle while allowing for an angular adjustment of the position of said mounting in relation to said middle, within a predefined angular range; and
positioning elements configured to securely attach said indexing member in rotation to said mounting,
third fixing elements cooperating with said first fixing elements to allow for assembly of said mounting on said middle; and
immobilizing elements securely attached to said indexing member and configured to cooperate with said positioning elements to prevent rotation of said indexing member with respect to said mounting.

9. The case of claim 8, wherein said first fixing elements comprise a first threading securely attached to said mounting, and wherein said third fixing elements comprise a second threading formed on said middle and configured to be meshed with said first threading.

10. The case of claim 9, wherein said first and second threadings are arranged and dimensioned so as to define said predefined angular range, corresponding to angular positions of said mounting in relation to said middle, wherein said mounting and said middle are securely attached to one another.

11. The case of claim 10, further comprising a seal interposed between said mounting and said middle so as to be compressed within said predefined angular range.

12. The case of claim 10, wherein said predefined angular range is between 0 and 10 degrees.

13. The case of claim 11, in which said predefined angular range is between 0 and 10 degrees.

14. The case of claim 8, wherein said immobilizing elements comprise at least one tab of said indexing member.

15. The case of claim 8, further comprising mounting elements configured to allow for a rotary assembling of said revolving bezel on said mounting.

16. The case of claim 15, wherein said mounting elements comprise:
a lateral groove formed on an outer wall of said mounting;
partially threaded holes passing through said revolving bezel in a radial direction; and
screws, each having a body that is at least partially threaded and configured to cooperate with one of said holes, each screw having a non-threaded end configured to slide in said groove.

17. A timepiece including a case comprising:
a middle;
a revolving bezel having teeth and at least one marker on a visible face;
an indexing member configured to cooperate with said teeth to index angular positions of said revolving bezel;
a revolving bezel system comprising:
a mounting bearing said indexing member and on which said revolving bezel is mounted and configured to rotate;
first fixing elements and second fixing elements configured to securely attach said mounting and said middle while allowing for an angular adjustment of the position of said mounting in relation to said middle, within a predefined angular range; and
positioning elements configured to securely attach said indexing member in rotation to said mounting,
third fixing elements cooperating with said first fixing elements to allow for assembly of said mounting on said middle; and
immobilizing elements securely attached to said indexing member and configured to cooperate with said positioning elements to prevent rotation of said indexing member with respect to said mounting.

18. The timepiece of claim 17, wherein said first fixing elements comprise a first threading securely attached to said mounting, and wherein said third fixing elements comprise a second threading formed on said middle and configured to be meshed with said first threading.

19. The timepiece of claim 18, wherein said first and second threadings are arranged and dimensioned so as to define said predefined angular range, corresponding to angular positions of said mounting in relation to said middle, wherein said mounting and said middle are securely attached to one another.

20. The timepiece of claim 19, further comprising a seal interposed between said mounting and said middle so as to be compressed within said predefined angular range.
